(19) United States
(12) Patent Application Publication
(10) Pub. No.: US 2026/0106551 A1
(43) Pub. Date: Apr. 16, 2026

(54) DRIVING CIRCUIT, DRIVING CHIP AND SWITCHING POWER SUPPLY

(71) Applicant: Silergy Semiconductor Technology (Hangzhou) LTD, Hangzhou (CN)

(72) Inventors: Xiangdong Yang, Hangzhou (CN); Zhiliang Hu, Hangzhou (CN)

(21) Appl. No.: 19/350,364

(22) Filed: Oct. 6, 2025

(30) Foreign Application Priority Data
Oct. 12, 2024 (CN) 202411426139.2

(51) Int. Cl. H02M 3/335; H02M 1/08; H02M 1/36

(52) U.S. Cl. CPC H02M 3/33507; H02M 1/08; H02M 1/36

(57) ABSTRACT

A driving circuit can include: a driving voltage generation circuit having a positive input terminal receiving a first driving voltage, a negative input terminal receiving a second driving voltage, and an output terminal coupled to a control terminal of a power switch; a negative voltage circuit configured to generate the second driving voltage for driving the power switch, where the second driving voltage is a negative voltage; and where a time when the second driving voltage is generated is earlier than a time when the power switch starts to operate in a normal operation phase.

### RELATED APPLICATIONS

This application claims the benefit of Chinese Patent Application No. 202411426139.2, filed on Oct. 12, 2024, which is incorporated herein by reference in its entirety.

### FIELD OF THE INVENTION

The present invention generally relates to the field of power electronics, and more particularly to switching converters, and associated driving circuits and methods.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example switching power supply.

FIG. 2 is a waveform diagram of example operation of a switching power supply.

FIG. 3 is a schematic block diagram of an example driving circuit and an example switching power supply, in accordance with embodiments of the present invention.

FIG. 4 is a structural schematic diagram of an example driving circuit, in accordance with embodiments of the present invention.

FIG. 5 is a partial structural schematic diagram of an example negative voltage circuit, in accordance with embodiments of the present invention.

FIG. 6 is a waveform diagram of example operation of an example driving circuit, in accordance with embodiments of the present invention.

FIG. 7 is a structural schematic diagram of an example state selection circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Silicon carbide (SiC) transistors are increasingly used in high-voltage applications due to their high withstand voltage and low switching losses. SiC transistors have relatively small parasitic capacitance and fast switching speed. As such, when a high voltage change rate (dv/dt) caused by the rapid switching of the transistor is loaded on the control terminal of the transistor, the transistor can be turned on by mistake. Therefore, in order to enhance reliability, negative voltage driving may generally be used, such that when the transistor is turned off, the voltage of the control terminal of the transistor is pulled to a lower value. This can prevent the voltage of the control terminal of the transistor from instantaneously rising above the turn-on threshold of the transistor caused by the crosstalk and being turned on by mistake.

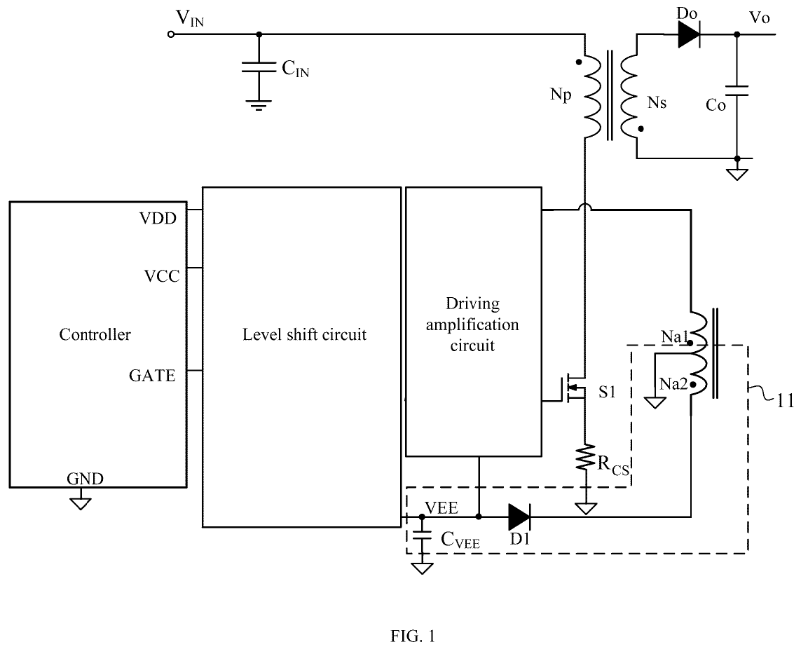

Referring now to FIG. 1, shown is a schematic block diagram of an example switching power supply. In this particular example, the switching power supply can include a driving circuit having a controller and a peripheral circuit to drive SiC transistor S1. The peripheral circuit can include a level shift circuit, a driving amplification circuit, and negative voltage supply circuit 11. The level shift circuit can convert the driving voltage output by the controller from the control terminal of SiC transistor S1 to ground terminal GND into the driving voltage from the control terminal to negative voltage VEE. The voltage from the control terminal to negative voltage VEE can be amplified by the driving amplification circuit, in order to increase the driving capability. Negative voltage supply circuit 11 can include auxiliary winding Na2, diode D1, and capacitor C_{VEE}. Negative voltage supply circuit 11 can generate negative voltage V_{EE} through auxiliary winding Na2, where V_{EE}=−Vo*Nₐ₂/Nₛ, Vo is the output voltage of the switching power supply, and Nₐ₂ and Nₛ are the respective turns of auxiliary winding Na2 and secondary winding Ns. In this approach, negative voltage VEE generated by negative voltage supply circuit 11 may only start to follow output voltage Vo after the controller generates the PWM signal and the switching power supply controlled by the PWM signal operates normally to generate output voltage Vo.

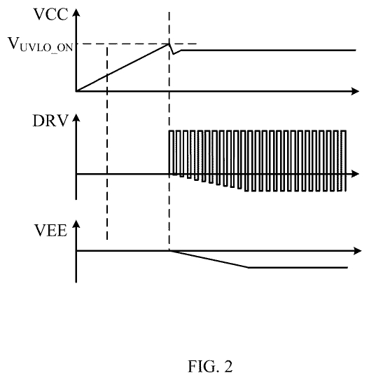

Referring now to FIG. 2, shown is a waveform diagram of operation of a switching power supply. In this particular example, the controller can start operating after the power supply voltage VCC reaches startup threshold V_{UVLO_ON}. Negative voltage VEE may need to be generated slowly through auxiliary winding Na2 after the controller operates, e.g., after driving voltage DRV is generated. At the initial stage of the operation of the controller, because output voltage Vo is low and negative voltage VEE is also low, the risk of mis-turn-on due to the crosstalk is relatively high when transistor S1 is controlled to be turned off. This approach generally has numerous peripheral components, a complex structure, and relatively low reliability. Some manufacturers may even omit the negative voltage driving design to save costs, resulting in even worse reliability.

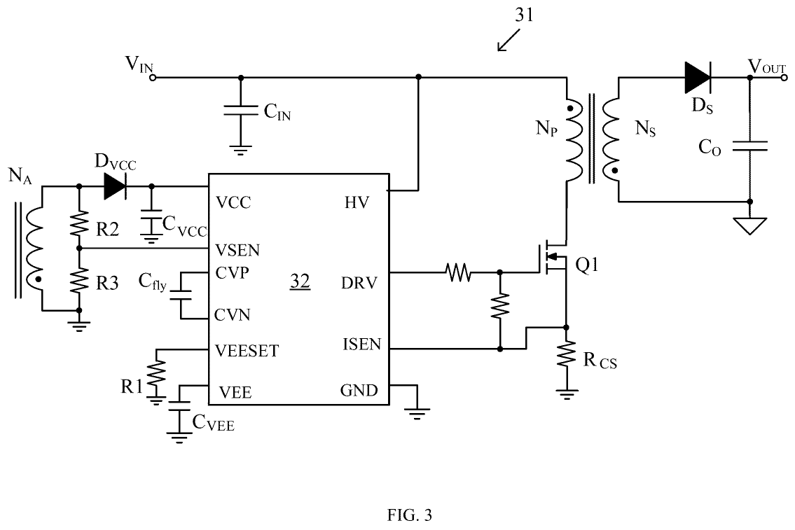

Referring now to FIG. 3, shown is a schematic block diagram of an example driving circuit and an example switching power supply, in accordance with embodiments of the present invention. In this particular example, the switching power supply is configured as a flyback converter. The flyback converter can include power stage circuit 31 and driving circuit 32. Power stage circuit 31 can include primary winding Np and power switch Q1 connected in series between the input terminal and the ground potential.

In particular embodiments, current sampling resistor Rcs may also be provided between power switch Q1 and the ground potential. In this example, input capacitor C_{IN} can connect between the input terminal and the ground potential. Power stage circuit 31 can also include secondary winding Ns and a secondary rectification circuit, where secondary winding Ns is coupled to primary winding Np. The secondary rectification circuit can connect to secondary winding Ns. In this example, the secondary rectification circuit can be configured as diode Ds. In this example, output capacitor Co can connect between the output terminal of the secondary rectification circuit and the secondary ground potential. Power stage circuit 31 can also include auxiliary winding N_{A} and a voltage dividing circuit that divides the voltage across auxiliary winding N_{A}.

In one embodiment, the voltage dividing circuit can include resistors R2 and R3. Auxiliary winding Na can be coupled to primary winding Np and secondary winding Ns. Information, such as output voltage V_{OUT} of power stage circuit 31, the zero-crossing moment of the current flowing through secondary winding Ns, and the valley moment of the current flowing through secondary winding Ns, can be obtained through the voltage across auxiliary winding Na. Therefore, by sampling the voltage generated by dividing the voltage across auxiliary winding N_{A}, the above information can be obtained and power switch Q1 can be controlled based on the such information/signals. Optionally, auxiliary winding N_{A} can be coupled to driving circuit 32 through diode D_{VCC}, in order to provide supply voltage VCC for driving circuit 32.

When power switch Q1 is a silicon carbide (SiC) transistor or another suitable type of transistor with a relatively small parasitic capacitance and fast switching speed, driving circuit 32 can be provided with negative voltage driving, in order to prevent unintended turn-on of power switch Q1. In this way, when power switch Q1 is turned off, the voltage at the control terminal of power switch Q1 can be pulled down to the negative voltage, in order to prevent the voltage of the control terminal of power switch Q1 from instantaneously rising above the turn-on threshold of power switch Q1 caused by the crosstalk and being turned on by mistake.

In order to optimize the scheme in FIG. 1 and reduce peripheral devices of the chip, this example integrates most components in the negative voltage circuit providing the negative voltage power supply function in driving circuit 32 into the chip. Thus, only a few components may need to be arranged outside the chip. For example, driving circuit 32 may only place resistor R1, capacitor C_{fly}, and capacitor C_{VEE} of the negative voltage circuit external to the chip, whereby the remaining components of the negative voltage circuit are placed inside the chip.

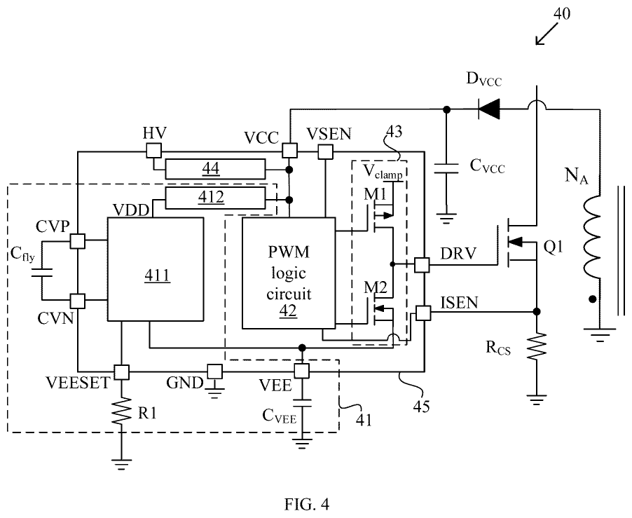

Referring now to FIG. 4, shown is a structural schematic diagram of an example driving circuit, in accordance with embodiments of the present invention. In this particular example, driving circuit 40 can include negative voltage circuit 41, PWM logic circuit 42, and driving voltage generation circuit 43. Here, at least some components of negative voltage circuit 41, PWM logic circuit 42, and driving voltage generation circuit 43, can be packaged within the same driving chip 45. For example, negative voltage circuit 41 can include resistor R1, capacitor C_{fly}, and capacitor C_{VEE} disposed external to driving chip 45. Linear regulator circuit 412 for converting power supply voltage VCC into operating voltage VDD with a corresponding amplitude, and aggregate module 411 including other modules of negative voltage circuit 41, can be packaged inside driving chip 45.

Negative voltage circuit 41 may receive power supply voltage VCC, convert power supply voltage VCC into operating voltage VDD, and can convert operating voltage VDD into driving voltage VEE for driving power switch Q1, where driving voltage VEE is a negative voltage. Further, the amplitude of driving voltage VEE can be consistent with (e.g., the same as) the amplitude of operating voltage VDD, and operating voltage VDD can be a positive voltage. In addition, a time when driving voltage VEE is generated can be earlier than a time when the power switch starts to operate in a normal operation phase. In the “normal operation” phase, the power switch can operate in on and off states periodically.

In particular embodiments, the resistance value of resistor R1 in negative voltage circuit 41 can be adjustable, may correspond to the rated driving voltage of power switch Q1. As such, operating voltage VDD with an amplitude suitable for power switch Q1 to be driven in this case can be selectively generated in negative voltage circuit 41, and the driving circuit can be compatible with different transistors. In one example, the resistance value of resistor R1 can be positively related to a rated driving voltage of the power switch. In another example, the resistance value of resistor R1 can be negatively related to a rated driving voltage of the power switch. In yet another example, the resistance value of resistor R1 can correspond to a rated driving voltage of the power switch in any way as required in a particular application.

In particular embodiments, resistor R1 can connect to a first current source. The current from the first current source can flow through resistor R1 to generate a first voltage across resistor R1. Also, a voltage indication signal can be generated by determining the voltage range of the first voltage, where the voltage indication signal can indicate the value of operating voltage VDD. In this example, linear regulator circuit 412 may receive the voltage indication signal, in order to convert power supply voltage VCC into operating voltage VDD corresponding to the voltage indication signal. Since the amplitude of driving voltage VEE may be consistent with the amplitude of operating voltage VDD, negative voltage circuit 41 can generate driving voltage VEE suitable for power switch Q1 in this case, in order to ensure reliable turn-off of power switch Q1. In one embodiment, the voltage indication signal can indicate the value of driving voltage V_{clamp}, in order to ensure reliable turn-on of power switch Q1. In another example, negative driving voltage VEE may ensure reliable turn-on of power switch Q1, and the value of driving voltage V_{clamp} can ensure reliable turn-off of power switch Q1.

PWM logic circuit 42 can generate PWM signal(s) indicating the operating states of power switch Q1 based on at least one sampling signal. In one example, PWM logic circuit 42 may receive a current sampling signal from current sense resistor R_{CS} and a voltage sampling signal from auxiliary winding N_{A}, in order to generate the PWM signal. Driving voltage generation circuit 43 coupled to PWM logic circuit 42 can generate driving signal DRV of power switch Q1 according to the PWM signal. The voltage of driving signal DRV can be clamped to driving voltage V_{clamp} or driving voltage VEE based on the states of the PWM signal.

In this example, power switch Q1 may turn on with a high level on its control terminal, and off with a low level on its control terminal. When the PWM signal indicates that power switch Q1 needs to be turned on, the voltage of the control terminal of power switch Q1 can be clamped to driving voltage V_{clamp}, where driving voltage V_{clamp} is a positive voltage and may ensure reliable turn-on of power switch Q1. When the PWM signal indicates that power switch Q1 needs to be turned off, the voltage of the control terminal of power switch Q1 can be clamped to driving voltage VEE, where driving voltage VEE is a negative voltage and may ensure reliable turn-off of power switch Q1.

Any suitable type of power switch Q1 can be utilized in certain embodiments, and as such power switch Q1 can alternatively be a type of transistor that turns on with a low level and turns off with a high level. In this case, when the PWM signal indicates that power switch Q1 needs to be turned on, the voltage of the control terminal of power switch Q1 can be clamped to driving voltage VEE, where driving voltage VEE is a negative voltage and may ensure reliable turn-on of power switch Q1. Also in this case, when the PWM signal indicates that power switch Q1 needs to be turned off, the voltage of the control terminal of power switch Q1 can be clamped to driving voltage V_{clamp}, where driving voltage V_{clamp} is a positive voltage and may ensure reliable turn-off of power switch Q1.

In one embodiment, driving voltage generation circuit 43 can include transistors M1 and M2 connected in series. One power terminal of transistor M1 may receive driving voltage V_{clamp}, the other power terminal of transistor M1 can connect to one power terminal of transistor M2, and the other power terminal of transistor M2 may receive driving voltage VEE. Driving signal DRV can be output at the common node of transistors M1 and M2. Driving signal DRV can be clamped to driving voltage V_{clamp} when transistor M1 is turned on, and clamped to driving voltage VEE when transistor M2 is turned on.

For example, when the level state of the PWM signal indicates that power switch Q1 needs to be turned on, transistor M1 can be turned on, driving signal DRV may be clamped to driving voltage V_{clamp}, and the control terminal of power switch Q1 can be pulled to a high level such that power switch Q1 is turned on. When the level state of the PWM signal indicates that power switch Q1 needs to be turned off, transistor M2 can be turned on, driving signal DRV may be clamped to driving voltage VEE, and the control terminal of power switch Q1 can be pulled to a low level such that power switch Q1 is turned off. Since driving voltage VEE is a negative voltage, even if a relatively high voltage change rate (i.e., dv/dt) caused by rapid switching of the transistor couples to the control terminal of power switch Q1, it is less likely for the voltage at the control terminal of power switch Q1 to rise above its turn-on threshold. In this way, unintended turn-on of power switch Q1 can be substantially avoided, thus enhancing system reliability in particular embodiments.

Driving circuit 40 can also include high-voltage startup circuit 44. Referring to FIGS. 3 and 4, high-voltage startup circuit 44 can be coupled to the input terminal of the switching power supply to receive input voltage V_{IN}, thereby generating power supply voltage VCC to start the chip. Optionally, power supply voltage VCC may be provided by high-voltage startup circuit 44 during the startup phase, and provided by auxiliary winding N_{A} in the normal operation phase. In one example, auxiliary winding NA can generate power supply voltage VCC on capacitor C_{VCC} through diode D_{VCC}, and may supply power supply voltage VCC to driving chip 45 through power supply pin VCC of driving chip 45. In addition, the output terminal of high-voltage startup circuit 44 can be coupled to power supply pin VCC of driving chip 45. In one embodiment, PWM logic circuit 42 may also be powered by power supply voltage VCC.

Driving chip 45 can include power supply pin VCC coupled to auxiliary winding NA to receive power supply voltage VCC, whereby auxiliary winding N_{A} is coupled to an inductive device in the switching power supply. External capacitor pins CVP and CVN, can respectively be coupled to the two ends of capacitor C_{fly}, where capacitor C_{fly} and two half-bridge circuits inside driving chip 45 may form a charge pump circuit to generate driving voltage VEE which is a negative voltage. Negative voltage pin VEE can be coupled to capacitor C_{VEE} to generate driving voltage VEE across capacitor C_{VEE}. Driving pin DRV can be coupled to the control terminal of power switch Q1, and may be configured to output driving voltage V_{clamp} or driving voltage VEE based on the PWM signal indicating the operating states of power switch Q1. Negative voltage adjustment pin VEESET can be coupled to resistor R1, where the resistance value of resistor R1 may be adjustable and can correspond to the rated driving voltage of power switch Q1. Additionally, driving chip 45 can include voltage detection pin VSEN and current detection pin ISEN.

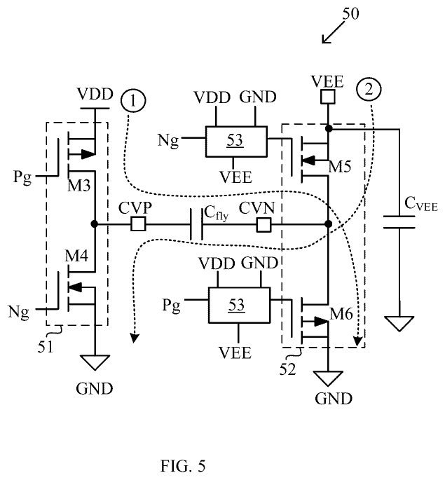

Referring now to FIG. 5, shown is a partial structural schematic diagram of an example negative voltage circuit, in accordance with embodiments of the present invention. This particular example mainly shows the circuit structure diagram of negative voltage circuit 41 converting operating voltage VDD into driving voltage VEE for driving power switch Q1. In this example, negative voltage circuit 41 can convert operating voltage VDD into a negative voltage (e.g., the driving voltage VEE) through the charge pump circuit.

Charge pump circuit 50 can include half-bridge circuit 51, half-bridge circuit 52, capacitor C_{fly}, and capacitor C_{VEE}. Half-bridge circuit 51 can be coupled between the output terminal of operating voltage VDD and the ground potential. Half-bridge circuit 52 can be coupled between the output terminal of driving voltage VEE and the ground potential. Capacitor C_{fly} can connect between the output node of half-bridge circuit 51 and the output node of half-bridge circuit 52. Capacitor C_{VEE} can connect in parallel with half-bridge circuit 52.

The example operating process of charge pump circuit 50 may be as follows. When transistors M3 and M6 are turned on, causing path 1 to conduct, the voltage relationship is VCP−VCN=VDD. Then, after path 1 is turned off, when transistors M4 and M5 are turned on, causing path 2 to conduct, since the voltage of capacitor C_{fly} cannot change abruptly, and V_{CVP}=0, the voltage relationship may become VEE=VCN−VCP=−VDD, such that operating voltage VDD with positive voltage can be converted into driving voltage VEE with negative voltage, and the amplitudes of operating voltage VDD and driving voltage VEE are equal. Therefore, the amplitude of driving voltage VEE can also be adjusted by adjusting the amplitude of operating voltage VDD to meet the driving requirements of power switch Q1.

For example, transistors M3 and M6 can be turned on/off based on the same control signal Pg, and transistors M4 and M5 may be turned on/off based on the same control signal Ng. Further, since half-bridge circuit 52 is coupled between the output terminal of driving voltage VEE and the ground potential, charge pump circuit 50 can also be provided with level shift circuit 53. Level shift circuit 53 may receive the control signals for half-bridge circuit 52, and convert the amplitude of the control signals from being relative to the ground potential to being relative to driving voltage VEE, in order to adapt to the driving conditions of the transistors in half-bridge circuit 52.

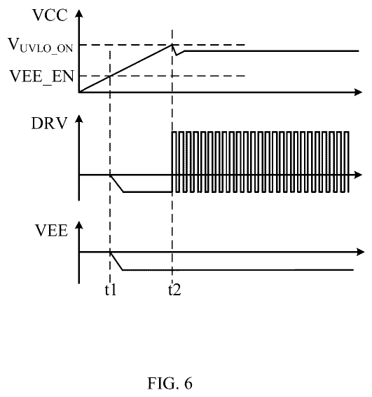

Referring now to FIG. 6, shown is a waveform diagram of example operation of an example driving circuit, in accordance with embodiments of the present invention. In this particular example, when power supply voltage VCC reaches threshold VEE_EN (e.g., at time t1), negative voltage circuit 41 can be enabled and may start operating, directly converting power supply voltage VCC into driving voltage VEE. When power supply voltage VCC reaches threshold V_{UVLO_ON} (e.g., startup threshold V_{UVLO_ON} of the driving chip), driving chip 45 may start operating, and PWM logic circuit 42 can output the PWM signal, where threshold VEE_EN is less than threshold V_{UVLO_ON}.

Referring to FIGS. 4 and 6, when driving circuit 40 is started, input voltage VIN can charge capacitor C_{VCC} through high-voltage pin HV and high-voltage startup circuit 44 to generate power supply voltage VCC. When power supply voltage VCC reaches threshold VEE_EN, negative voltage circuit 41 can be enabled, power supply voltage VCC can be converted into operating voltage VDD by linear regulator circuit 412 in negative voltage circuit 41, and operating voltage VDD may then be converted into driving voltage VEE by charge pump circuit 50; that is, driving voltage VEE may start to be generated. By setting appropriate peripheral circuits and internal thresholds, driving voltage VEE can reach a stable preset value before power supply voltage VCC reaches startup threshold V_{UVLO_ON}, and the PWM signal may start to be generated after power supply voltage VCC reaches startup threshold V_{UVLO_ON}. In this way, the problem as discussed above whereby driving voltage VEE starts to be generated only after the PWM signal is generated can be substantially avoided.

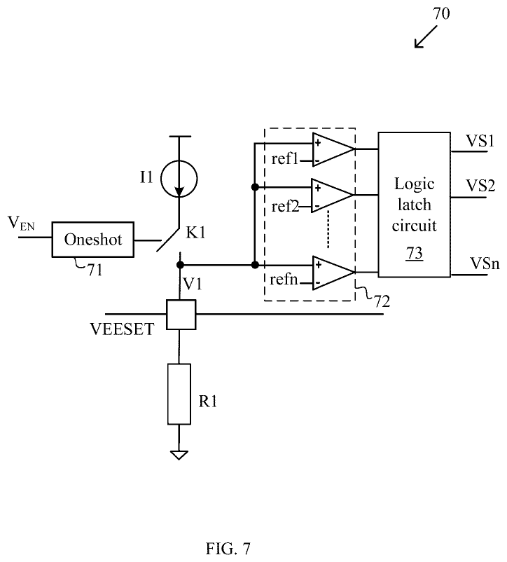

Referring now to FIG. 7, shown is a structural schematic diagram of an example state selection circuit, in accordance with embodiments of the present invention. In this particular example, negative voltage circuit 41 can include state selection circuit 70, which can include resistor R1, switch K1, current source I1, one-shot circuit 71, comparison circuit 72, and logic latch circuit 73. For example, resistor R1 can connect to current source I1. When power supply voltage VCC reaches threshold VEE_EN, enable signal VEN can become active, and switch K1 controlled by enable signal VEN can turn on. At this time, the current of current source I1 may generate voltage V1 across resistor R1. Voltage indication signal VSi can be generated by determining the voltage range in which voltage V1 falls, where voltage indication signal VSi can indicate the value of operating voltage VDD. For example, 1≤i≤n, and n is an integer not less than 2. In certain embodiments, any suitable structure of state selection circuit 70, as long as it can achieve voltage range recognition, may be employed.

For example, comparison circuit 72 may have multiple comparators corresponding to multiple reference voltages ref1 through refn. Voltage V1 can be respectively compared against multiple reference voltages ref1 through refn, in order to generate multiple comparison signals. Logic latch circuit 73 can perform logical operations on the level states of the multiple comparison signals, and can latch the results of the logic operation to generate voltage indication signals VS1 through VSn, where voltage indication signal VSi can characterize the voltage range in which voltage V1 falls. Since the resistance value of resistor R1 is adjustable and the resistance value of resistor R1 corresponds to the rated driving voltage of power switch Q1, the driving chip may internally obtain the driving voltage requirement corresponding to the particular application scenario through resistor R1. Consequently, negative voltage circuit 41 can selectively generate operating voltage VDD with amplitudes suitable for power switch Q1 that needs to be driven in the current usage scenario and driving voltage V_{clamp}, thus achieving multi-step adjustment of the driving voltage. In this way, the driving circuit of certain embodiments may be compatible with different transistors.

Particular embodiments may include a negative voltage circuit that generates a negative voltage through a charge pump circuit. Most components of the negative voltage circuit can be integrated inside the driving chip, thus requiring fewer peripheral components for the driving chip, and making application more convenient. Further, at the initial stage of generation of power supply voltage VCC, negative voltage VEE can begin to be generated, and before the PWM signal is output, negative voltage VEE can reach the set voltage value, thus effectively substantially preventing the transistor from being turned on by mistake. In this way, the amplitude of the negative voltage in certain embodiments can be adjusted in multiple steps, which is suitable for different transistor requirements.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A driving circuit, comprising:
a) a driving voltage generation circuit having a positive input terminal receiving a first driving voltage, a negative input terminal receiving a second driving voltage, and an output terminal coupled to a control terminal of a power switch;
b) a negative voltage circuit configured to generate the second driving voltage for driving the power switch, wherein the second driving voltage is a negative voltage; and
c) wherein a time when the second driving voltage is generated is earlier than a time when the power switch starts to operate in a normal operation phase.

2. The driving circuit of claim 1, wherein the driving circuit further comprises:
a) a PWM logic circuit configured to generate a PWM signal indicating operating states of the power switch based on at least one sampling signal;
b) wherein the driving voltage generation circuit generates a driving signal for the power switch based on the PWM signal; and
c) wherein a voltage of the driving signal is clamped to be the first driving voltage when the PWM signal is at a first level, and wherein the voltage of the driving signal is clamped to be the second driving voltage when the PWM signal is at a second level.

3. The driving circuit of claim 1, wherein at least some components of the negative voltage circuit, the PWM logic circuit, and the driving voltage generation circuit, are configured to be integrated within one chip.

4. The driving circuit of claim 1, wherein the second driving voltage is configured as a negative voltage to ensure that the power switch is reliably turned on or off.

5. The driving circuit of claim 1, wherein:
a) the negative voltage circuit receives a power supply voltage, converts the power supply voltage into an operating voltage, and converts the operating voltage into the second driving voltage; and
b) an amplitude of the second driving voltage is consistent with an amplitude of the operating voltage, and the operating voltage is a positive voltage.

6. The driving circuit of claim 5, wherein the negative voltage circuit comprises:
a) a first half-bridge circuit coupled between an output terminal of the operating voltage and a ground potential;
b) a second half-bridge circuit coupled between an output terminal of the second driving voltage and the ground potential;
c) a first capacitor coupled between an output node of the first half-bridge circuit and an output node of the second half-bridge circuit; and
d) a second capacitor coupled in parallel with the second half-bridge circuit.

7. The driving circuit of claim 6, wherein:
a) the negative voltage circuit further comprises a first resistor and a first current source;
b) a current of the first current source flows through a first resistor to generate a first voltage across the first resistor;
c) a voltage indication signal is generated by determining a voltage range of the first voltage; and
d) the voltage indication signal is used to indicate a value of the operating voltage.

8. The driving circuit of claim 7, wherein a resistance value of the first resistor is adjustable, and the resistance value of the first resistor corresponds to a rated driving voltage of the power switch.

9. The driving circuit of claim 7, wherein the negative voltage circuit further comprises a first linear regulator circuit configured to convert the power supply voltage into the operating voltage with a corresponding amplitude according to the voltage indication signal.

10. The driving circuit of claim 7, wherein the first resistor, the first capacitor, and the second capacitor in the negative voltage circuit are disposed external to a driving chip, and remaining components of the negative voltage circuit are disposed inside the driving chip.

11. The driving circuit of claim 6, wherein the negative voltage circuit further comprises a level shift circuit that is configured to receive a control signal of the second half-bridge circuit, and to convert an amplitude of the control signal from relative to the ground potential to relative to the second driving voltage.

12. The driving circuit of claim 2, wherein:
a) when the power supply voltage reaches a first threshold, the negative voltage circuit is enabled to convert an operating voltage into the second driving voltage;
b) when the power supply voltage reaches a second threshold, the PWM logic circuit is enabled to output the PWM signal; and
c) the first threshold is less than the second threshold.

13. The driving circuit of claim 2, wherein the PWM logic circuit is powered by the power supply voltage.

14. The driving circuit of claim 5, wherein the power supply voltage is provided by a high-voltage startup circuit coupled to an input terminal of the switching power supply during a startup phase, and is provided by an auxiliary winding in the normal operation phase.

15. The driving circuit of claim 5, further comprising a second linear regulator circuit configured to convert the power supply voltage into the first driving voltage, wherein the first driving voltage is a positive voltage.

16. A switching power supply, comprising the driving circuit of claim 1, and further comprising a power stage circuit configured to perform voltage conversion on an input voltage to generate an output voltage.

17. A driving chip for driving a power switch in a switching power supply, the driving chip comprising:
a) a power supply pin coupled to an auxiliary winding to receive a power supply voltage, wherein the auxiliary winding is coupled to an inductive device in the switching power supply;
b) two external capacitor pins, respectively coupled to two ends of a first capacitor, wherein the first capacitor and two half-bridge circuits inside the driving chip form a charge pump circuit to generate a second driving voltage that is a negative voltage;
c) a negative voltage pin coupled to a second capacitor to generate the second driving voltage across the second capacitor; and
d) a driving pin coupled to a control terminal of the power switch, configured to output a first driving voltage or the second driving voltage based on a PWM signal indicating operating states of the power switch.

18. The driving chip of claim 17, further comprising a negative voltage adjustment pin coupled to a first resistor, wherein a resistance value of the first resistor is adjustable, and wherein the resistance value of the first resistor corresponds to a rated driving voltage of the power switch.

19. The driving chip of claim 17, wherein the charge pump circuit converts the power supply voltage into an operating voltage, and converts the operating voltage into the second driving voltage, and wherein an amplitude of the second driving voltage is consistent with an amplitude of the operating voltage, and the operating voltage is a positive voltage.

20. The driving chip of claim 17, wherein a time when the second driving voltage is generated is earlier than a time when the power switch starts to operate in a normal operation phase.
